(19) United States
(12) Patent Application Publication
(10) Pub. No.: US 2017/0038751 A1
(43) Pub. Date: Feb. 9, 2017

(54) PROCEDURES FOR ASSESSING A SIGNAL

(71) Applicant: Dürr Assembly Products GmbH, Puttlingen (DE)

(72) Inventors: CHRISTIAN PETZINGER, HEUSWEILER (DE); KURT ISMAIL, VOLKLINGEN (DE); HOLGER PFEIL, RIEGELSBERG (DE)

(21) Appl. No.: 15/179,208

(22) Filed: Jun. 10, 2016

(30) Foreign Application Priority Data
Jun. 12, 2015 (DE) 102015109448.7

(51) Int. Cl. G05B 19/048; B25B 23/142; G05B 23/02

(52) U.S. Cl. CPC G05B 19/048; G05B 23/0267; B25B 23/1425; G05B 2219/23098

(57) ABSTRACT

This invention relates to a procedure for assessing a signal representing the manual actuating force acting on an adjusting tool for the electrical, pneumatic and/or hydraulic actuation of adjusting means which, at least in the operational state in which the adjusting tool interacts with the adjusting means, serve for the alignment of units and/or sensors of a vehicle. According to this invention, the adjusting tool's drive is blocked if the manual actuating force exceeds a threshold value and/or if a measuring signal representing the alignment of the unit and/or of the sensor is assessed as incorrect and not allowed and/or a signal indicating an error status is generated.

### PRIOR APPLICATIONS

This application claims priority to and all advantages of German Patent Application No. DE 102015109448.7, filed on Jun. 12, 2015, the content of which is hereby incorporated by reference.

### TECHNICAL FIELD

As set forth in claim 1, the present invention relates to a procedure for assessing a signal according to the preamble of claim 1.

### BACKGROUND

The signal represents the manual actuating force acting on an adjusting tool for the electrical, pneumatic and/or hydraulic actuation of adjusting means, which, at least in the operational state in which the adjusting tool interacts with the adjusting means, serve for the alignment of units and/or sensors of a vehicle. The adjusting means are actuated electrically, pneumatically and/or hydraulically. The manual actuating force is not, therefore, the force with which the adjusting means are actuated for the purpose of aligning units and/or sensors. This force results from the electrical, pneumatic and/or hydraulic actuation. The manual actuating force, for its part, is the force with which the adjusting tool is applied in each case to the adjusting means. If the adjusting means consist of adjusting screws, for example, the adjusting tool is applied to the screw with a manual actuating force. This manual actuating force must be large enough to prevent the adjusting tool from slipping off the screw when the latter is driven electrically, pneumatically and/or hydraulically.

Possible examples of units and sensors include a vehicle's headlamps, a camera for observing the space behind a vehicle or a sensor for recording data for use in ACC systems. Units and sensors of this kind must be aligned in accordance with the vehicle body's x direction (vehicle's longitudinal direction), y direction (vehicle's transverse direction) and z direction, (vertical direction). Instead of their being aligned in accordance with the vehicle body's x- and y directions, the units and sensors may also be aligned in accordance with the vehicle's geometric travel axis, which—at least within specified tolerances for the adjustment of the geometric travel axis via the respective vehicle wheel parameters toe and camber angle—coincide with the x direction.

The adjusting means may be adjusting screws, for example, which relate to the orientation of the units and/or sensors. These adjusting means are not to be confused with the fastening means with which the units and/or sensors are fastened mechanically to the vehicle body. After they have been fastened mechanically, the units and/or sensors are aligned by means of the adjusting means.

The units and/or sensors are fastened to the vehicle body particularly in the frontal area thereof. Depending on the vehicle model, this frontal area may take the form of a lower front panel made of plastic or of a frontal vehicle component made of thin sheet metal intended to deform and yield in the event of possible accidents involving persons. Also in the case of a sensor and/or unit being attached in the rear area of a vehicle—for example a camera for observing the space behind a vehicle—it may be attached to the lower back panel in an area which may be made of plastic and designed to yield, enabling it to deform and absorb forces generated by small accidents at low speeds or to save weight.

This means that the vehicle body is able to deform precisely in the area to which a force is applied. If the force is removed again, the affected vehicle component returns in this case to its original shape The reason for this is that, compared with an accident, the forces generated by manual pressure of an adjusting tool on the adjusting means are limited compared with those generated in an accident.

It is possible for the mechanic himself to actuate the adjusting tool and thus to influence the adjusting means. Actuation of the adjusting tool may also be automated in that, once it has been positioned on the adjusting means, the tool is driven to act as drive for the adjusting means until the alignment of the unit or sensor has been identified as correct.

### SUMMARY

The objective of this invention is to simplify the alignment of units and sensors of this kind.

This objective is established according to claim 1 in that the adjusting tool's drive is blocked if the manual actuating force exceeds a threshold value and/or if a measuring signal representing the alignment of the unit and/or of the sensor is assessed as incorrect and not allowed and/or a signal indicating an error status is generated.

This solution makes provision for the problem that the influence of a manual actuating force on the adjusting tool causes the body to deform if this manual actuating force is large enough.

If the alignment of the unit and/or of the sensor is measured while the body is in this deformed state, an alignment might be measured that is identified as being correct. If the adjusting tool is removed, meaning that it no longer exerts a manual actuating force on the body that causes the latter to deform, the body relaxes and returns to its original shape.

The alignment of the unit and/or of the sensors now differs from what was measured in the deformed state of the body as being correct.

The problem now is that the alignment in the vehicle body's “relaxed state” is incorrect despite its having been identified as correct during the measurement.

The manual actuating force is the force with which the adjusting tool is pressed onto the adjusting means.

A first measure for solving the problem consists in blocking the adjusting tool's drive in the event of the manual activating force being identified as exceeding a threshold.

This proves particularly advantageous if, during execution of the adjustment work, the mechanic receives a signal indicating at least whether the momentary alignment is correct or not.

Optionally, the direction in which the adjusting means must be actuated in order to obtain an alignment identifiable as correct may also be signalized to the mechanic.

This embodiment may be refined still further if not only the direction in which the adjusting means must be actuated in order to obtain an alignment identifiable as correct but also the extent to which the adjusting means must be actuated—i.e. a measure of the how much the currently identified alignment differs from the alignment identifiable as being correct—is signalized to the mechanic.

This blocking of the adjusting tool is also realizable if, once it has been positioned on the adjusting means, the tool is driven in automated manner in order to align the unit and/or sensor correctly.

If the adjusting tool's drive is blocked during the adjustment work, the mechanic will immediately recognize that his manual actuating force is too great and that the alignment display may be erroneous at this moment. He will realize immediately, while still performing the adjustment work, that he must reduce his manual actuating force in order to obtain a proper display of the currently measured alignment or even to carry out the adjustment work at all.

This immediate feedback to the mechanic is in so far advantageous as it prevents a situation whereby the adjustment work is initially performed with too much actuating force on the part of the mechanic, resulting in the alignment initially being identified and possibly also signalized to the mechanic during the adjustment work as being correct and then, after removal of the adjusting tool and relaxing of the vehicle body, the actual alignment being incorrect.

Should the mechanic expressly wish to press the adjusting tool onto the adjusting means with a greater manual actuating force, a further actuating element may be provided. By actuating this element, the mechanic is able to bridge the adjusting tool's blocking function. This actuating element may be a push button, for example, which enables the blocking function to be bridged for as long as the push button is pressed down. The mechanic is then able to undo a jammed screw with the adjusting tool.

Additionally or alternatively, assessment of a signal representing the alignment of the unit and/or of the sensor as correct may be prevented in the event that the manual actuating force is identified as exceeding the threshold.

This relates to the confirmation—at the end of the measuring and adjustment procedure—that the alignment has been identified as correct and the process concluded.

The requirements for this confirmation may be recognized automatically by the system if, allowing for adjustment tolerances, the currently measured alignment is in agreement with the specified value.

If the current alignment is signalized to the mechanic, the confirmation may also consist in that the mechanic enters a confirmation signal once the adjustment work has been completed because he himself recognizes the alignment as being correct. In this embodiment, the “do not allow” or “prevent” function may consist in that entry of the confirmation signal by the mechanic is blocked. In this case, the mechanic receives immediate feedback to the effect that the conditions for performing an alignment measurement are not correct.

In this procedure, the proper measurement conditions are monitored if the concluding measurement is intended, for example, for purposes of entering the alignment as correct in a log.

With this embodiment—in this case not in addition to the previously described measure of blocking the adjusting tool—a greater manual actuating force may be exerted during the adjustment work if, for example, an adjusting screw serving as adjusting means has jammed and the adjusting tool needs to be pressed down briefly with a greater manual actuating force in order to move the screw. The higher manual actuating force enables the adjusting tool to be pressed into the screw to the effect that, in the case of a jammed screw, the tool does not twist as easily out of its engagement recess in the screw head. In a situation of this kind it is advantageous if the adjusting tool does not block immediately if it is pressed down with a manual actuating force in excess of the threshold value. For the actual measurement, by contrast, the manual actuating force is evaluated.

Alternatively or in addition, a signal indicating an error status may be generated.

Control over the adjustment work may be left with the mechanic if this signal is merely to assist him.

In the case of any one of the previously described measures, such as blocking of the adjusting tool or prevention of an alignment from being identified as correct, it is also useful to generate an information signal for the mechanic enabling him to distinguish the operational-error status from a system malfunction.

In the embodiment according to claim 2, the measuring system is integrated in the adjusting tool or is assigned to the adjusting tool.

The measuring system for an adjusting tool may, for example, consist of a spring, which is compressed by the manual actuating force. An end position may be defined in this context, at which a switch/push-button contact is closed in order to indicate that this end position has been reached. The adjusting tool may, in this case, consist of two parts that are movable relative to each other in the direction of the manual actuating force. The two parts are pressed apart by the spring, so that, when a manual actuating force is applied, the spring is compressed.

In this way, a comparatively simple arrangement is provided for measuring the manual actuating force acting on the adjusting tool.

This corresponds to the embodiment described in claim 3, according to which the signal is derived in consequence of a spring being compressed or extended by the actuating force and an end-position switch is assigned to the spring travel.

In the embodiment according to claim 4, the measuring signal is assessed as being incorrect by blocking the entry by the mechanic of a signal confirming a correct measurement.

The mechanic thus obtains feedback to the effect that no proper conditions exist for performing an alignment measurement.

In the embodiment according to claim 5, the signal indicating the error status is generated in optical, acoustic and/or haptic form.

A haptic signal may be realized, for example, by providing the adjusting tool with a drivable weight having an imbalance. The adjusting tool will vibrate when this weight is driven. Generating the signal in this form has the advantage that the user receives feedback easily, largely irrespective of other ambient conditions such as noise or poor lighting.

An acoustic signal may take the form of a beep, for example.

An optical signal may be made visible on a display device.

Tools are known in which the drive is started up when tool contact is identified. An embodiment of this kind may optionally be combined with the procedure according to this invention. The measured actuating force will then be evaluated to see whether it exceeds a lower threshold value. This lower threshold value may correspond approximately to the adjusting tool's own weight, which acts on the means coupling the tool with the adjusting means on the vehicle. If the manual actuating force exceeds this lower threshold value, this is a criterion for starting up the drive for the coupling means. If, by contrast, the manual actuating force exceeds not only this lower threshold value but also the threshold value within the meaning of the present invention, the measures suggested within the framework of this invention will be adopted. The threshold value as defined in this invention is greater than the lower threshold value.

### BRIEF DESCRIPTION OF THE DRAWING

Other advantages of the present invention will be readily appreciated, as the same becomes better understood by reference to the following detailed description when considered in connection with the accompanying drawing, wherein:

FIG. 1 shows an adjusting tool.

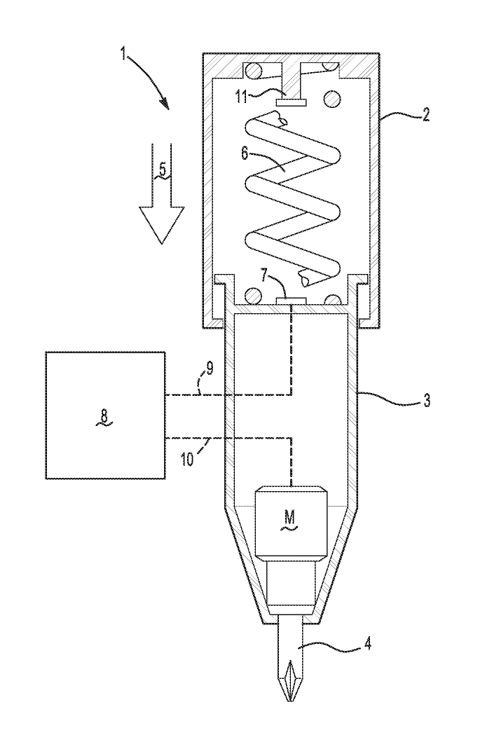

### DETAILED DESCRIPTION

An embodiment of the invention is shown in the drawing, which shows an adjusting tool 1 consisting of two parts 2 and 3. The adjusting tool has a coupling means 4 for an adjusting means, which, in the embodiment shown, is an adjusting screw. In the embodiment shown, the coupling means 4 is a bit for a screw.

The coupling means 4 is driven by an electric motor located in the adjusting tool 1.

The adjusting tool 1 is applied to the adjusting means in the axial direction 5 of the adjusting tool 1 by the mechanic. The mechanic grips this adjusting tool in the part 2 thereof. Application of the coupling means 4 to the adjusting screw causes the generation of a counter-force acting in the axial direction 5 against the manual actuating force.

The adjusting means is actually moved by the rotation of the coupling means 4.

This rotation is generated by the electric motor inside the adjusting tool 1.

The manual actuating force as defined in this application is merely the force with which the adjusting tool 1 is applied to the adjusting means. The driving power for moving the adjusting means is auxiliary power, and has nothing directly to do with this manual actuating force.

It is also evident that the two parts 2 and 3 of the adjusting tool 1 can be moved axially relative to each other. These two parts 2 and 3 are pressed apart by means of a spring force 6.

If the adjusting tool 1 is pressed onto an adjusting means via a manual actuating force that exceeds a threshold value, the spring 6 is compressed sufficiently to close an electrical push-button contact 7. For this purpose, the part 2 also contains a plunger 11, which closes the push-button contact when the two parts 2 and 3 are pushed together. Closure of this push-button contact 7 triggers a signal representing a manual actuating force on the adjusting tool 1 that is higher than the threshold value.

Instead of a system involving a position switch for measuring the actuating force, the applied force may also be measured continuously and the measured value compared with the threshold value.

It is evident that the signal triggered via the push-button contact 7 is supplied to an evaluating unit 8 as an input signal 9.

An output signal 10 from the evaluating unit 8 in supplied in turn to the adjusting tool 1. The adjusting tool 1 is controlled via this output signal 10. In particular, the function by which the adjusting tool is blocked, in so far as this function is implemented, is realized via this output signal 10. Optionally, this output signal optionally also controls the generation of the haptic information signal, in the form of vibration of the adjusting tool 1.

The evaluating unit 8 may also be an integral component of the adjusting tool 1.

Obviously, many modifications and variations of the present invention are possible in light of the above teachings. The foregoing invention has been described in accordance with the relevant legal standards; thus, the description is merely exemplary than limiting in nature. Variations and modifications to the disclosed embodiment may become apparent to those skilled in the art and do come within the scope of the invention. Accordingly the scope of the legal protection afforded this invention can only be determined by studying the following claims.

1. Procedure for assessing a signal representing the manual actuating force acting on an adjusting tool (1) for the electrical, pneumatic and/or hydraulic actuation of adjusting means which, at least in the operational state in which the adjusting tool (1) interacts with the adjusting means, serve for the alignment of units and/or sensors of a vehicle, said manual actuating force being the force with which the adjusting tool (1) is pressed onto the adjusting means,
characterized in that the drive of the adjusting tool (1) is blocked (8, 10) if the manual actuating force (6, 7) exceeds a threshold value and/or if a measuring signal representing the alignment of the unit and/or of the sensor is assessed as incorrect and not allowed and/or a signal indicating an error status is generated (8, 10).

2. Procedure according to claim 1,
characterized in that the measuring system (6, 7) is integrated in the adjusting tool (1) or is assigned to the adjusting tool (1).

3. Procedure according to either of claim 1 or 2,
characterized in that the signal is derived in consequence of a spring (6) being compressed or extended by the manual actuating force, an end-position switch (7) being assigned to the spring travel.

4. Procedure according to any one of the claims 1 to 3,
characterized in that the measuring signal is assessed as being incorrect by blocking the entry of a signal confirming a correct measurement by the mechanic.

5. Procedure according to any one of the claims 1 to 3,
characterized in that the signal indicating the error status is generated as an optical, acoustic and/or haptic signal (10).
